(19) United States
(12) Patent Application Publication
(10) Pub. No.: US 2024/0424798 A1
(43) Pub. Date: Dec. 26, 2024

(54) LIQUID EJECTION APPARATUS

(71) Applicant: CANON KABUSHIKI KAISHA, Tokyo (JP)

(72) Inventors: MAIKO SHIINA, Tokyo (JP); TAKAYA SATO, Tokyo (JP); TETSUJI SUZUKI, Kanagawa (JP); RAN KUDO, Tokyo (JP)

(21) Appl. No.: 18/748,977

(22) Filed: Jun. 20, 2024

(30) Foreign Application Priority Data
Jun. 23, 2023 (JP) 2023-103661

(51) Int. Cl. B41J 2/17; B41J 2/155

(52) U.S. Cl. CPC B41J 2/1714; B41J 2/155

(57) ABSTRACT

A liquid ejection apparatus includes an ejection head, a conveyance unit, an air delivery unit, and an intake unit. The ejection head ejects a liquid from an ejection portion to a first surface of an ejection target medium. The conveyance unit faces the ejection portion and conveys the ejection target medium in a first direction. The air delivery unit is arranged downstream of the ejection head in the first direction and delivers air to the conveyance unit. The intake unit faces the air delivery unit and intakes at least a portion of the air delivered by the air delivery unit. The intake unit includes a mist collection portion that collects mist generated by the ejection of the liquid from the ejection portion.

### BACKGROUND

### Field

The present disclosure relates to a liquid ejection apparatus.

### Description of the Related Art

Inkjet recording apparatuses are known as liquid ejection apparatuses for recording text and images by ejecting ink from recording heads to a recording medium. In the foregoing recording apparatuses, spray mist may be generated during the ink ejection, and in a case where the mist adheres to the recording heads, the ink ejection may be obstructed, and this may cause a decrease in ink landing accuracy. Japanese Patent Laid-Open No. 2019-93591 discusses a configuration in which a conveyance mechanism including a plurality of belt suction holes conveys a recording medium while suctioning the recording medium, and mist is suctioned upward by suction portions provided both upstream and downstream of an inkjet head in a conveyance direction.

However, with a configuration discussed in Japanese Patent Laid-Open No. 2019-93591, mist that is not successfully suctioned by suction portions may move downstream in a conveyance direction and adhere to a member in a liquid ejection apparatus.

### SUMMARY

The present disclosure provides a liquid ejection apparatus capable of collecting mist appropriately.

According to an aspect of the present disclosure, a liquid ejection apparatus includes an ejection head configured to eject a liquid from an ejection portion to a first surface of an ejection target medium, a conveyance unit facing the ejection portion and configured to convey the ejection target medium in a first direction, an air delivery unit arranged downstream of the ejection head in the first direction and configured to deliver air to the conveyance unit, and an intake unit facing the air delivery unit and configured to intake at least a portion of the air delivered by the air delivery unit, wherein the intake unit includes a mist collection portion configured to collect mist generated by the ejection of the liquid from the ejection portion.

Further features of the present disclosure will become apparent from the following description of exemplary embodiments with reference to the attached drawings.

### BRIEF DESCRIPTION OF THE DRAWINGS

FIG. 1 is a schematic diagram illustrating a recording apparatus according to an aspect of the present disclosure.

FIG. 2 is a diagram illustrating a configuration of a printing belt unit according to an aspect of the present disclosure.

FIG. 3 is a diagram illustrating a configuration of a suction unit according to an aspect of the present disclosure.

FIGS. 4A and 4B are diagrams illustrating a configuration of an air curtain unit according to an aspect of the present disclosure.

FIGS. 5A and 5B are schematic views illustrating a flow of collecting mist according to a first exemplary embodiment.

FIGS. 6A and 6B are schematic views illustrating a flow of collecting mist according to a second exemplary embodiment.

FIGS. 7A, 7B, and 7C are schematic views illustrating a flow of collecting mist according to a third exemplary embodiment.

### DESCRIPTION OF THE EMBODIMENTS

Various preferred exemplary embodiments of the present disclosure will be described in detail below. It is to be noted that the scope of the present disclosure should not be limited unfairly to the following descriptions and not all configurations according to the exemplary embodiments described below are essential components of the present disclosure.

### (Recording Apparatus)

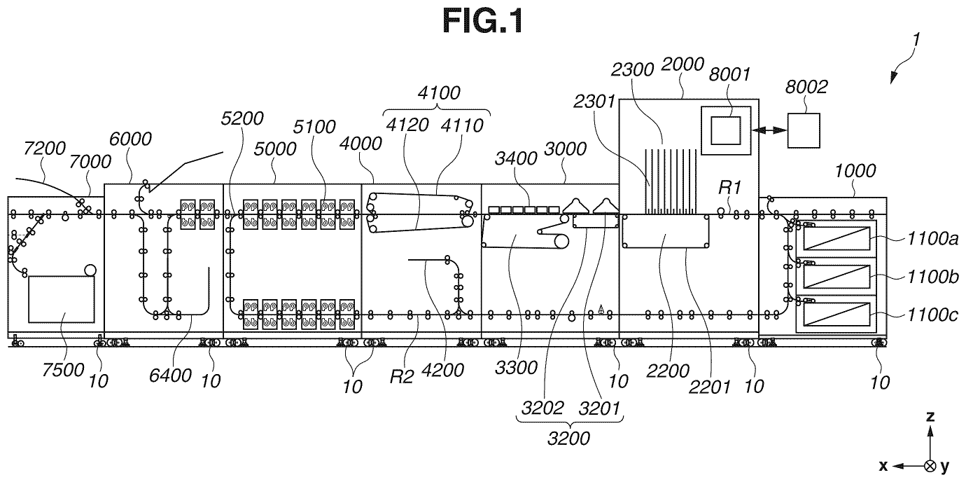

In FIG. 1, three arrows X, Y, and Z are illustrated. The arrows X, Y, and Z are mutually orthogonal and respectively correspond to X, Y, and Z directions. According to a first exemplary embodiment, the X, Y, and Z directions respectively indicate a width direction (overall length direction), a depth direction, and a height direction of a recording apparatus 100. A +X direction of the X direction indicates a conveyance direction of a recording medium 101. A −X direction of the X direction indicates the opposite direction to the +X direction. A +Z direction of the Z direction indicates upward. A −Z direction of the Z direction indicates downward. Further, a surface of the recording medium 101 that faces the +Z direction will be referred to as “upper surface”, and a surface of the recording medium 101 that faces the −Z direction will be referred to as “lower surface”. An inkjet recording apparatus (hereinafter, “recording apparatus 1”) will be described below as an example of a liquid ejection apparatus to which the present disclosure is applicable.

FIG. 1 is a schematic diagram illustrating an example of an outline configuration of the recording apparatus 1. The recording apparatus 1 is a sheet-fed inkjet recording apparatus that generates a recorded material by forming an image on a sheet S using two types of liquids that are a reaction solution and an ink.

The recording apparatus 1 according to the present exemplary embodiment includes a sheet feeding module 1000, a printing module 2000, a drying module 3000, a fixing module 4000, a cooling module 5000, a reversing module 6000, and a discharged sheet stacking module 7000. The sheet S in a cut-sheet form is fed from the sheet feeding module 1000, conveyed along a conveyance path R1 indicated with solid lines in FIG. 1, processed by the modules, and discharged to the discharged sheet stacking module 7000. The modules 1000 to 7000 are each covered with a cover (not illustrated) and are each provided with casters 10 at the bottom so that the modules 1000 to 7000 can move independently.

The sheet feeding module 1000 includes three storage sections 1100a to 1100c configured to store the sheets S, and the storage sections 1100a to 1100c can be pulled out in the −Y direction. The sheets S are singly fed from the storage sections 1100a to 1100c by a separation belt (not illustrated) and a conveyance roller (not illustrated) and conveyed to the printing module 2000. The storage sections 1100a to 1100c are not limited to three storage sections and may be composed of one, two, four or more storage sections.

The printing module 2000 includes a pre-image-formation registration correction portion (not illustrated), a printing belt unit 2200, and a recording portion 2300. The printing belt unit 2200 and the recording portion 2300 are a conveyance unit. The recording portion 2300 is arranged to face the printing belt unit 2200 in the Z direction with respect to the conveyance path R1.

The recording portion 2300 is a sheet processing portion that performs a recording process (printing) by ejecting ink to a front surface (first surface) of the sheet S. The recording portion 2300 includes recording heads 2301 as liquid ejection heads, and the recording heads 2301 include nozzles as ejection portions. The nozzles eject ink and are arranged on a surface that faces the conveyed sheet S. The recording portion 2300 is composed of the plurality of recording heads 2301 arranged in the X direction.

According to the present exemplary embodiment, the recording heads 2301 include recording heads configured to eject four colors of ink, which are yellow (Y), magenta (M), cyan (C), and black (Bk), and a recording head configured to eject a reaction solution. According to the present exemplary embodiment, the recording heads 2301 is a line recording head (a line head, a full line head) provided with ejection portions in a region having a length corresponding to a maximum length (width) of the sheet S in the Y direction that can be conveyed by the recording apparatus 1. The number of colors and the number of recording heads are not limited to five, and the recording heads 2301 may be a serial-type recording head that ejects ink while moving with respect to the sheet S. An inkjet method that uses heating elements, piezo elements, electrostatic elements, or micro-electro-mechanical systems (MEMS) elements may be employed. The different colors of ink and the reaction solution are supplied from ink tanks (not illustrated) through flexible tubes to the corresponding recording heads 2301.

The reaction solution that is used in the present exemplary embodiment can reduce the fluidity of some of the ink and/or ink compositions on the sheet S when brought into contact with the ink. Specifically, by bringing a reaction agent (component that increases the ink viscosity) contained in the reaction solution into contact with a color material or resin that is a part of the composition constituting the ink, the reaction agent reacts chemically or is adsorbed physically. This causes an increase in viscosity of the entire ink or causes an increase in local viscosity due to aggregation of some of the components constituting the ink, such as the color materials. Increasing the viscosity decreases the fluidity of some of the ink and/or ink composition. Decreasing the fluidity prevents bleeding and beading.

The tilt and position of the sheet S conveyed from the sheet feeding module 1000 are corrected by the pre-image-formation registration correction portion, and the sheet S is conveyed to the printing belt unit 2200. The printing belt unit 2200 conveys the sheet S while a back surface (second surface) of the sheet S is being suctioned to the printing belt unit 2200 (suction conveyance), and the recording heads 2301 perform the recording process on the sheet S while maintaining a clearance between the recording heads 2301 and the sheet S.

The drying module 3000 includes a decoupling portion 3200, a drying belt unit 3300, and a warm air blow unit 3400 and is a unit that decreases the liquid content of the ink applied onto the sheet S by the recording portion 2300 and increases the fixability between the sheet S and the ink. The sheet S having undergone the printing process by the recording portion 2300 of the printing module 2000 is conveyed to the decoupling portion 3200 arranged in the drying module 3000. The decoupling portion 3200 includes an air delivery unit 3201 and a conveyance belt 3202 facing the air delivery unit 3201. The air delivery unit 3201 delivers air to the sheet S, and the conveyance belt 3202 conveys the sheet S in the +X direction. The air delivery unit 3201 delivers air by blowing the air in the −Z direction and presses the sheet S against the conveyance belt 3202. The press generates friction force between the sheet S and the conveyance belt 3202, so that the conveyance belt 3202 can convey the sheet S. The conveyance belt 3202 prevents misalignment of the sheet S conveyed from the printing belt unit 2200 by conveying the sheet S while lightly holding the sheet S using the friction force.

The sheet S conveyed from the decoupling portion 3200 is suctioned and conveyed by the drying belt unit 3300. The warm air blow unit 3400 is arranged to face the drying belt unit 3300 and dries the ink on the sheet S by blowing warm air in the −Z direction. Besides the drying method by applying warm air, a method of irradiating the surface of the sheet S with electromagnetic waves (such as ultraviolet or infrared rays) and/or a conduction heat transfer method involving bringing a heating member into contact may be used in combination.

The fixing module 4000 includes a fixing belt unit 4100 including an upper belt unit 4110 and a lower belt unit 4120. The upper belt unit 4110 and the lower belt unit 4120 are heated by a heating unit (not illustrated). The sheet S conveyed from the drying module 3000 is conveyed while being sandwiched between the upper belt unit 4110 and the lower belt unit 4120, whereby the ink is fixed to the sheet S.

The cooling module 5000 includes a plurality of cooling portions 5100 arranged along the conveyance path R1 and cools the sheet S conveyed from the fixing module 4000. The cooling portions 5100 bring outside air into a cooling box (not illustrated) using a fan (not illustrated), increase the pressure inside the cooling box, and blows the air from nozzles onto the sheet S to decrease the temperature of the sheet S. A plurality of units of the cooling portions 5100 is arranged along the conveyance path R1, and each unit includes the cooling portions 5100 arranged both above and below the conveyance path R1 in the Z direction. This configuration makes it possible to cool the sheet S efficiently from both surfaces.

The cooling module 5000 includes a conveyance path switching portion 5200 to switch the conveyance path for the sheet S between a case where the sheet S is to be conveyed to the reversing module 6000 and a case where the sheet S is to be conveyed to a two-sided conveyance path R2. In two-sided printing in which the printing process is performed on the back surface of the sheet S after performing printing on the front surface of the sheet S and drying the sheet S, the sheet S is conveyed along the two-sided conveyance path R2 through the fixing module 4000, the drying module 3000, the printing module 2000, and the sheet feeding module 1000. The two-sided conveyance path R2 of the fixing module 4000 includes a first reversing portion 4200 configured to reverse the front and back of the sheet S. The two-sided conveyance path R2 joins the conveyance path R1 in the sheet feeding module 1000, and the sheet S with the front and back reversed by the first reversing portion 4200 undergoes the printing process on the back surface (second surface) of the sheet S similarly to the printing process on the first surface of the sheet S.

The reversing module 6000 includes a second reversing portion 6400 to reverse the front and back of the conveyed sheet S. By selecting whether to convey the sheet S through the second reversing portion 6400 of the reversing module 6000, whether to discharge the sheet S face-up or face-down from the discharged sheet stacking module 7000 can be changed freely. The sheet S having passed through the reversing module 6000 is discharged to the discharged sheet stacking module 7000 and aligned and stacked on a top tray 7200 or a stacking portion 7500.

A control unit 8000 is a unit configured to control the components of the recording apparatus 1. The control unit 8000 includes a central processing unit (CPU), a storage device, a controller including various control units, an external interface, and an operation unit 8001 via which a user performs input and output operations. Operations of the recording apparatus 1 are controlled based on instructions from the controller or a host apparatus 8002 such as a host computer connected to the controller via the external interface.

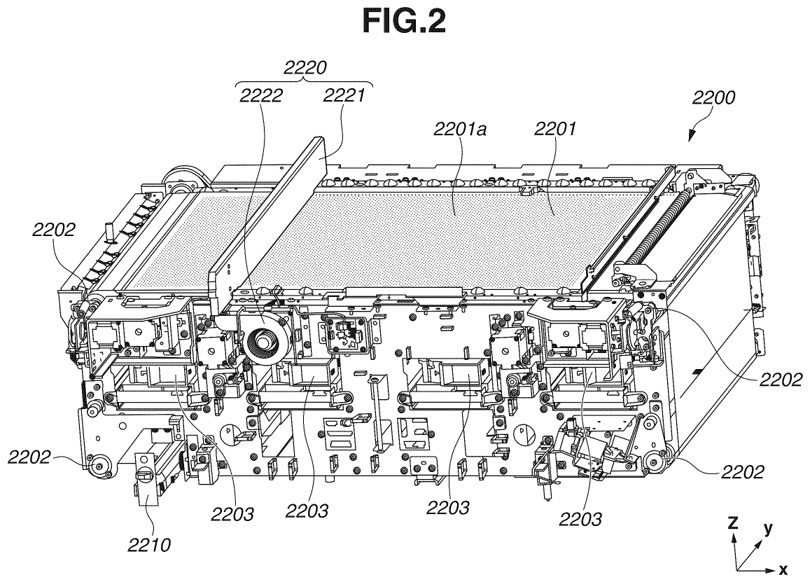

FIG. 2 is a diagram illustrating a configuration of the printing belt unit 2200. The printing belt unit 2200 includes a printing belt 2201, belt rollers 2202, suction units 2203, a cleaning unit 2210, and an air curtain unit 2220. The printing belt 2201 becomes a contact surface that is in contact with the sheet S in conveying the sheet S, and the printing belt 2201 includes a plurality of intake holes 2201a in the X and Y directions. The intake holes 2201a are through holes formed in a thickness direction of the printing belt 2201 and are distributed inside and outside of a region through which the sheet S passes in conveying the sheet S. The belt rollers 2202 maintains the tension of the printing belt 2201 at a constant level. The air curtain unit 2220 is an air delivery unit that is arranged to face the printing belt 2201 and generates an air curtain by blowing air to the printing belt 2201 in the −Z direction. The suction units 2203 suction the sheet S through the intake holes 2201a and intake at least some of the air blown from the air curtain unit 2220. The cleaning unit 2210 is brought into contact with the printing belt 2201 and removes mist and paper dust attached to a front surface of the printing belt 2201. While four suction units 2203 are provided to the printing belt unit 2200 according to the present exemplary embodiment, the number of suction units 2203 is not limited to four.

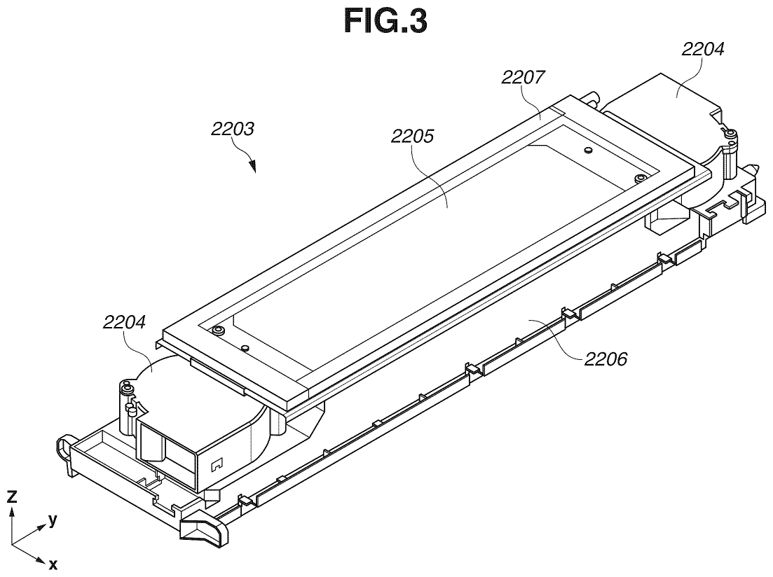

FIG. 3 is a diagram illustrating a configuration of one suction unit 2203. The suction unit 2203 includes suction fans 2204, a mist filter 2205, a suction base 2206, and a suction port seal 2207. The suction fans 2204 are arranged at both ends of the suction unit 2203 in the Y direction and discharge air in the suction base 2206 to the outside of the printing belt unit 2200. While the number of suction fans 2204 is two according to the present exemplary embodiment, the number of suction fans 2204 and orientations of the suction fans 2204 in the suction unit 2203 are not limited to those described above.

The suction base 2206 includes an opening portion in a surface facing the printing belt 2201, i.e., a surface on the +Z direction side in FIG. 3, and the opening portion is covered with the mist filter 2205. The mist filter 2205 is a mist collection portion. Around the mist filter 2205 is arranged the suction port seal 2207, and the suction port seal 2207 is pressed against a platen (not illustrated) supporting the printing belt 2201. The platen includes a plurality of holes (not illustrated), and by suctioning the sheet S to the printing belt 2201 through the holes of the platen and the intake holes 2201a by the suction units 2203 and rotating the printing belt 2201, the sheet S is conveyed in the +X direction. Further, mist discharged from the recording heads 2301 is collected along with an airflow suctioned by the suction fans 2204 through the intake holes 2201a of the printing belt 2201 by the mist filter 2205.

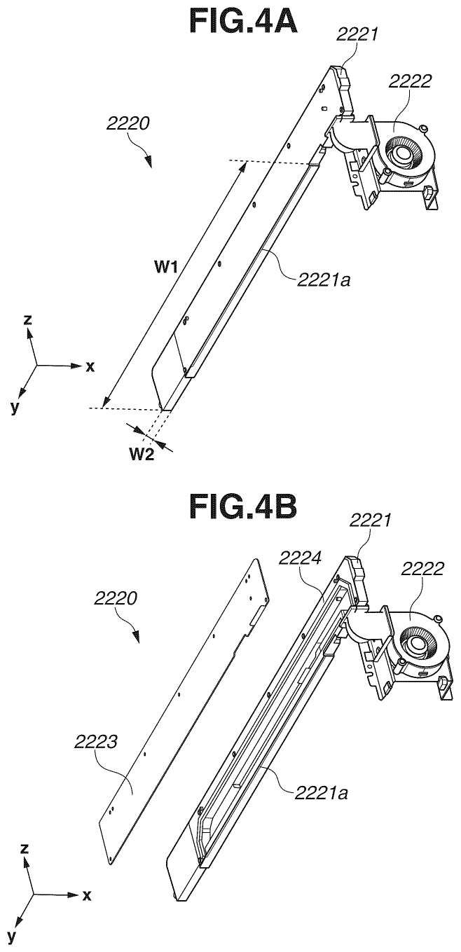

FIGS. 4A and 4B are diagrams illustrating a configuration of the air curtain unit 2220. FIG. 4A is an external view of the air curtain unit 2220, and FIG. 4B is a diagram illustrating an internal structure of the air curtain unit 2220. The air curtain unit 2220 includes an air curtain duct 2221 and an air curtain fan 2222. A surface (surface on the −Z direction side) of the air curtain duct 2221 that faces the printing belt 2201 includes an air outlet 2221a. The air outlet 2221a is an opening portion. The air curtain fan 2222 introduces air taken in from the outside of the printing belt unit 2200 into the air curtain duct 2221 and discharges the air from the air outlet 2221a to deliver the air.

A duct plate 2223 is a side wall of the air curtain duct 2221 and is fixed to the air curtain duct 2221, and a sponge-like seal portion 2224 is arranged between the air curtain duct 2221 and the duct plate 2223. An airflow flowing from the air curtain fan 2222 into the air curtain duct 2221 is blown in a curtain shape extending in the Y direction from the air outlet 2221a against the front surface of the printing belt 2201. A length W1 of the air outlet 2221a in the Y direction is formed to be greater than or equal to the maximum length of the sheet S in the Y direction that can be conveyed by the recording apparatus 1. Thus, even in a case where the sheet S is being conveyed, an airflow blown from the air curtain duct 2221 is blown against the front surface of the printing belt 2201 from end portions of the sheet S in the Y direction.

According to the present exemplary embodiment, the sheets S are conveyed consecutively so that the interval between the trailing edge of a preceding sheet and the leading edge of a following sheet is a predetermined distance. A length W2 of the air outlet 2221a in the X direction is configured to be smaller than the interval between the trailing edge of a preceding sheet and the leading edge of a following sheet. The flow velocity of air blown from the air outlet 2221a is set so that the sheet S being suctioned and conveyed does not curl or lift even in a case where the air hits edge portions of the sheet S. This makes it possible to convey the sheet S while maintaining the clearance between the sheet S and the recording heads 2301.

The airflow of air blown by the air curtain unit 2220 and the intake by the suction units 2203 are controlled by the control unit 8000. The airflow blown from the air outlet 2221a is controlled to be constant by the control unit 8000 based on the suction conveyance speed of the sheet S. This makes it possible to prevent mist discharged from the recording heads 2301 from flowing downstream even in a case where the sheets S are printed continuously at high speed or low speed.

### <Airflow During Mist Collection>

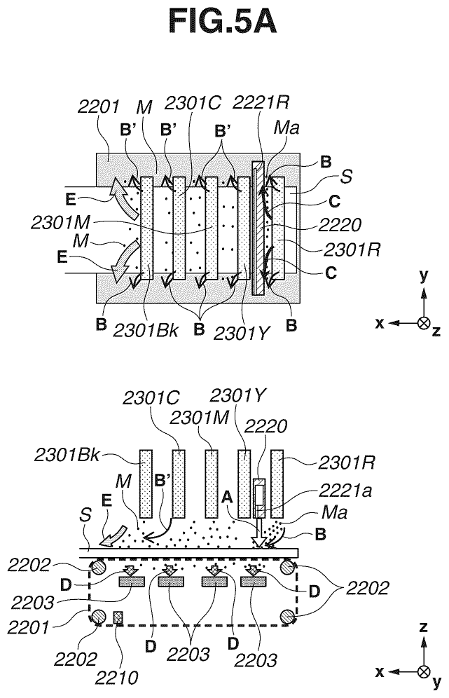

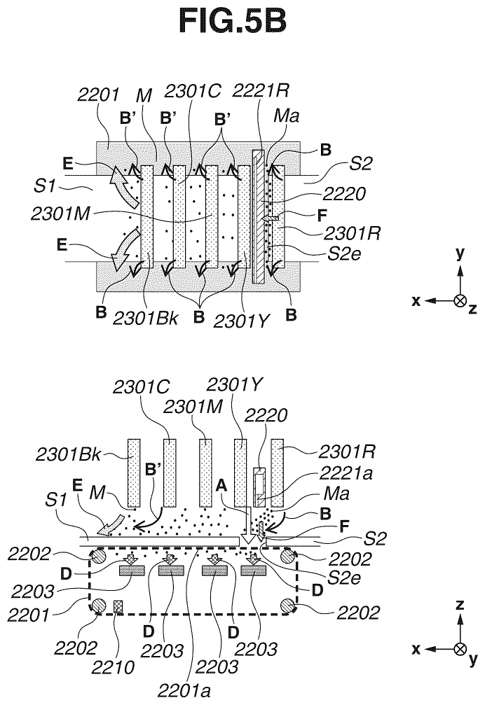

FIGS. 5A and 5B are schematic views illustrating a flow of collecting mist generated near the recording heads 2301. FIG. 5A is a view illustrating a state where the sheet S suctioned and conveyed by the printing belt 2201 is located under the air curtain unit 2220 as viewed from the Z and Y directions, and FIG. 5B illustrates a state where the sheet S is conveyed in the X direction and moved to a position downstream of the air curtain unit 2220 as viewed from the Z and Y directions.

According to the present exemplary embodiment, the recording portion 2300 includes a plurality of recording heads 2301R to 2301Bk arranged in the +X direction. The recording head 2301R ejects the reaction solution. The recording head 2301Y ejects the yellow (Y) ink. The recording head 2301M ejects the magenta (M) ink. The recording head 2301C ejects the cyan (C) ink. The recording head 2301Bk ejects the black (Bk) ink. The air curtain unit 2220 is arranged downstream of the recording head 2301R in the X direction and upstream of the recording head 2301Y in the X direction.

During the printing process by the recording heads 2301, as the reaction solution or ink is ejected from the recording heads 2301 to the sheet S, mist M, which is a cloud of small liquid droplets, is generated along with main droplets. The mist M is moved downstream (+X direction) in the conveyance direction by an airflow caused by the conveyance of the sheet S. In a case where mist Ma generated from the recording head 2301R is attached near the nozzles of the recording heads 2301Y to 2301Bk ejecting different colors of ink, the reaction solution may solidify through a reaction with the ink near the nozzles and block the nozzles, which may obstruct the ink ejection. A suitable example of a case where especially the amount of mist Ma generated from the recording head 2301R is greater than the amount of mist M generated from the recording heads 2301Y to 2301Bk of other colors according to the present exemplary embodiment will be described below.

In a case where the sheet S is located below the air curtain unit 2220 as illustrated in FIG. 5A, the mist Ma generated from the recording head 2301R flows in the +X direction due to an airflow caused by the conveyance of the sheet S. Meanwhile, a portion of the mist Ma is suctioned in arrow B directions by the suction units 2203 near both end portions of the sheet S in the Y direction due to an airflow taken in through the intake holes 2201a by the suction units 2203. The mist Ma generated near the center of the sheet S in the Y direction is not carried by the airflows along the arrows B because the sheet S is suctioned to the intake holes 2201a, and the mist Ma is moved in the +X direction by an airflow caused by the conveyance of the sheet S.

After the mist Ma flowing in the +X direction reaches near the air curtain unit 2220, the movement of the mist Ma in the +X direction is obstructed by an air curtain (arrow A) formed by the air outlet 2221a of the air curtain unit 2220. After the movement of the mist Ma in the +X direction is obstructed by the air curtain, the mist Ma is further moved in the +Y and −Y directions (arrow C), and after the mist Ma is moved near both ends of the sheet S in the Y direction, the mist Ma is collected by the mist filters 2205 of the suction units 2203 through the intake holes 2201a (arrow D). The mist Ma attached to a back surface of the printing belt 2201 or near the intake holes 2201a is wiped off and removed by the cleaning unit 2210 as the printing belt 2201 is rotated.

Like the mist Ma, the mist M generated from the recording heads 2301Y to 2301Bk flows in the +X direction due to an airflow caused by the conveyance of the sheet S. The mist M generated near both end portions of the sheet S in the Y direction are suctioned in arrow B′ directions through the intake holes 2201a by the suction units 2203. Mist generated near the center of the sheet S in the Y direction is not carried by the airflows along the arrows B′ because the sheet S is suctioned to the intake holes 2201a, and the mist is moved in the +X direction by an airflow caused by the conveyance of the sheet S.

Since the amount of generated mist M is less than the amount of generated mist Ma, the mist M is gradually suctioned in arrow E directions by suction through the intake holes 2201a near both ends of the sheet S in the Y direction while being moved in the +X direction, and the mist M is collected by the mist filters 2205 of the suction units 2203. Like the mist Ma, the mist M attached to the back surface of the printing belt 2201 or near the intake holes 2201a is wiped off and removed by the cleaning unit 2210 as the printing belt 2201 is rotated.

The mists Ma and M may be attached to the front surface of the printing belt 2201 outside of both ends of the region in the Y direction through which the conveyed sheet S passes, and the attached mists Ma and M may solidify. However, since the portions to which the mists Ma and M are attached are outside, in the Y direction, of the region through which the sheet S is conveyed, printing can be performed without adhesion of the solidified mists Ma and M to the sheet S. The mists Ma and M attached to the front surface of the printing belt 2201 may be removed by wiping by the user or by a removal mechanism.

A preceding sheet and a following sheet in conveying the sheets S consecutively will be referred to as a sheet S1 and a sheet S2, respectively. FIG. 5B illustrates a case where the sheet S1 is conveyed to a position downstream of the air curtain unit 2220 in the X direction. While the sheet S2 passes under the recording head 2301R, the mist Ma generated near both end portions of the sheet S2 in the Y direction is suctioned by the suction units 2203 through the intake holes 2201a (arrow B). However, the mist Ma that is not carried by the flow along the arrow B and remains is further conveyed in the +X direction by an airflow caused by the conveyance of the sheet S2.

As described above, the length of the air outlet 2221a of the air curtain unit 2220 in the X direction is configured to be shorter than the interval between the sheets S1 and S2. Thus, while the clearance between the sheets S1 and S2 passes under the air curtain unit 2220, the mist Ma is suctioned to the printing belt 2201 through the intake holes 2201a exposed without contacting the sheet S or the air curtain. The mist Ma having reached an end portion S2e of the sheet S2 on the +X direction side is blown in the −Z direction by the air curtain (arrow A) formed by the air outlet 2221a of the air curtain unit 2220. The movement of the mist Ma in the +X direction is obstructed by the air curtain, and the mist Ma is suctioned to the printing belt 2201 through the intake holes 2201a along a flow of an arrow F. The mist Ma suctioned to the printing belt 2201 passes through the intake holes 2201a of the printing belt 2201 and is collected by the mist filters 2205 of the suction units 2203 (arrow D). The mist Ma attached to the back surface of the printing belt 2201 or near the intake holes 2201a is wiped off and removed by the cleaning unit 2210 as the printing belt 2201 is rotated.

Like the mist Ma, the mist M generated by the recording heads 2301Y to 2301Bk of the respective colors flow in the +X direction due to an airflow caused by the conveyance of the sheet S. Meanwhile, near both end portions of the sheet S1 in the Y direction, a portion of the mist M is suctioned in the arrow B′ directions by the suction units 2203 due to an airflow with which the suction units 2203 suction the sheet S1 through the intake holes 2201a. The mist M generated near the center of the width of the sheet S in the Y direction is not carried by the airflow along the arrow B′ because the sheet S is suctioned to the intake holes 2201a, and the mist M is further moved in the +X direction by an airflow caused by the conveyance of the sheet S1. At this time, since the amount of generated mist M is less than the amount of generated mist Ma, the mist M is gradually suctioned in the arrow E directions near both end portions of the sheet S in the Y direction while being moved in the +X direction, and the mist M is collected by the mist filters 2205 of the suction units 2203. Further, the mist M attached to the back surface of the printing belt 2201 or near the intake holes 2201a is wiped off and removed by the cleaning unit 2210 as the printing belt 2201 is rotated.

As described above, arranging the air curtain unit 2220 between the recording heads 2301R and 2301Y makes it possible for the mist Ma to be collected by the mist filters 2205 while preventing the mist Ma from flowing downstream in the +X direction. Especially in a case where the amount of mist generated from the recording head 2301R is greater than the amount of mist generated from the recording heads 2301Y to 2301Bk, the mist generated from the recording head 2301R is prevented from adhering to the parts arranged downstream in the +X direction.

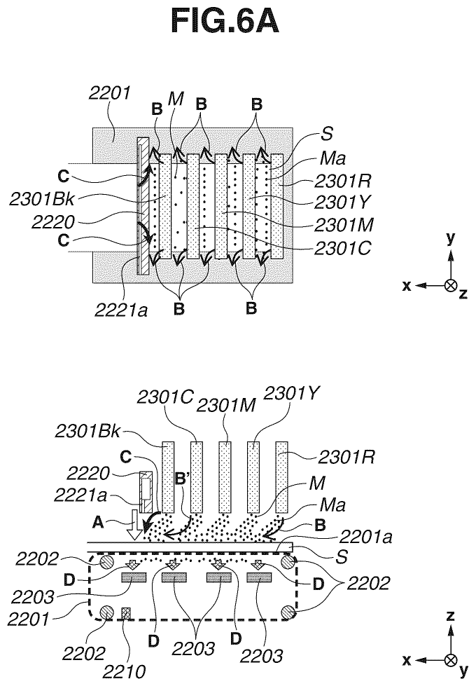

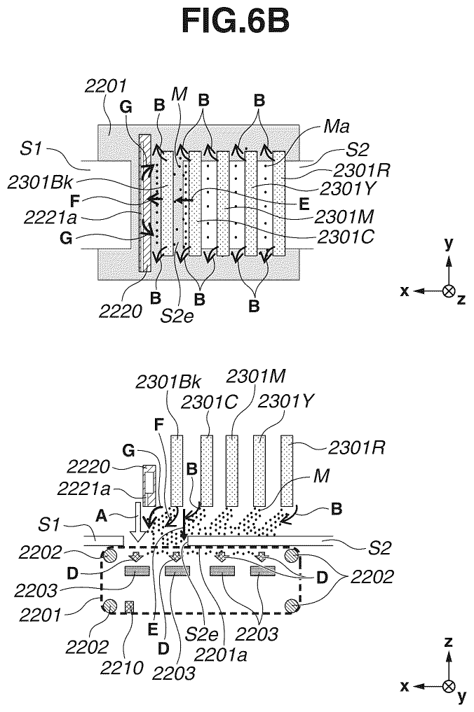

A configuration according to a second exemplary embodiment will be described below. Redundant descriptions of configurations similar to those according to the first exemplary embodiment are omitted. FIGS. 6A and 6B are schematic views illustrating a flow of collecting mist generated near the recording heads 2301 according to the second exemplary embodiment. FIG. 6A is a view illustrating a state where the suctioned and conveyed sheet S is located under the air curtain unit 2220 as viewed from the Z and Y directions, and FIG. 6B illustrates a state where the sheet S is conveyed in the X direction and moved to a position downstream of the air curtain unit 2220 as viewed from the Z and Y directions.

The recording head 2301R configured to eject the reaction solution, the recording head 2301Y configured to eject the Y ink, the recording head 2301M configured to eject the M ink, the recording head 2301C configured to eject the C ink, and the recording head 2301Bk configured to eject the Bk ink are arranged in this order from upstream in the conveyance direction (+X direction). According to the present exemplary embodiment, the air curtain unit 2220 is arranged downstream of the recording heads 2301Bk in the +X direction, and the air outlet 2221a and the printing belt unit 2200 face each other and blow air to the front surface of the printing belt 2201.

The small mists Ma and M generated from the recording heads 2301R to 2301Bk during printing on the sheet S are moved downstream in the conveyance direction (+X direction) by an airflow caused by the conveyance of the sheet S. In a case where the sheet S is located under the air curtain unit 2220 as illustrated in FIG. 6A, the mist M generated from the recording heads 2301Y to 2301Bk flows in the +X direction due to an airflow caused by the conveyance of the sheet S. Near both end portions of the sheet S in the Y direction, a portion of the mists Ma and M is suctioned in the arrow B directions by the suction units 2203 due to an airflow with which the suction units 2203 suction the sheet S through the intake holes 2201a. Near the center of the sheet S in the Y direction, the mists Ma and M are not carried by the airflow along the arrow B because the sheet S is suctioned to the intake holes 2201a, and the mists Ma and M are further moved in the +X direction by an airflow caused by the conveyance of the sheet S.

The airflow in the X direction is obstructed by the air curtain (arrow A) formed by the air curtain unit 2220, and the mists Ma and M having flowed near the air curtain unit 2220 are conveyed to both end portions of the sheet S in the Y direction (arrow C). The mists Ma and M conveyed to both end portions of the sheet S in the Y direction are collected by the mist filters 2205 of the suction units 2203 through the intake holes 2201a of the printing belt 2201 (arrow D).

FIG. 6B illustrates a case where the sheets S are conveyed consecutively. Due to the airflow caused by the conveyance and the airflow suctioned by the suction units 2203, a portion of the mist M discharged from the recording heads 2301Y to 2301Bk of the respective colors is suctioned from both end portions of the sheet S2 in the Y direction in the arrow B directions to the printing belt 2201. The mist M that is not carried by the flow along the arrow B and remains is further conveyed downstream in the conveyance direction by the airflow caused by the conveyance of the sheet S2. When the mist M reaches the end portion S2e of the sheet S2 in the X direction, the suction units 2203 suction the mist M through the intake holes 2201a of the printing belt 2201 that are exposed between the sheets S1 and S2 (arrow E). However, a portion of the mist M generated from the recording head 2301Bk configured to eject the Bk ink and located at the most downstream position in the conveyance direction is not suctioned to the printing belt 2201 and further flows downstream in the conveyance direction (arrow F).

While the clearance between the preceding sheet S1 and the following sheet S2 passes under the air curtain unit 2220, the mists Ma and M are blown by the air curtain (arrow A) in the −Z direction (arrow G) and suctioned to the printing belt 2201. The mist M suctioned to the printing belt 2201 is collected by the mist filters 2205 of the suction units 2203 through the intake holes 2201a of the printing belt 2201 (arrow D).

With the foregoing configuration, mists generated from the recording heads 2301 are obstructed by the air curtain unit 2220 arranged downstream of the recording head 2301 located at the most downstream position in the conveyance direction among the plurality of recording heads 2301, and the suction units 2203 suction and collect the mists. This makes it possible to prevent the mists from flowing downstream of the air curtain unit 2220 in the conveyance direction.

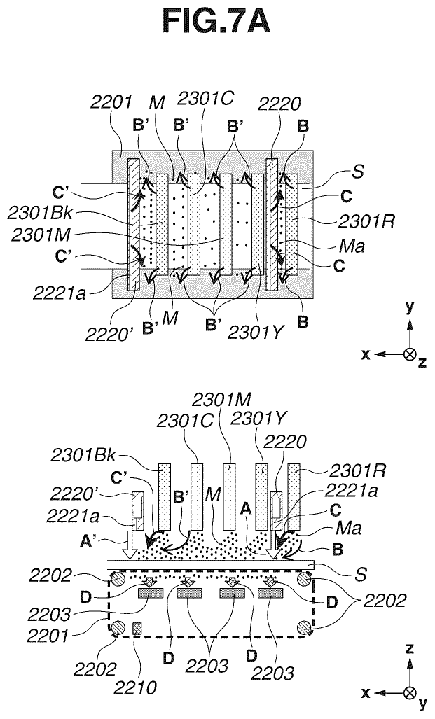

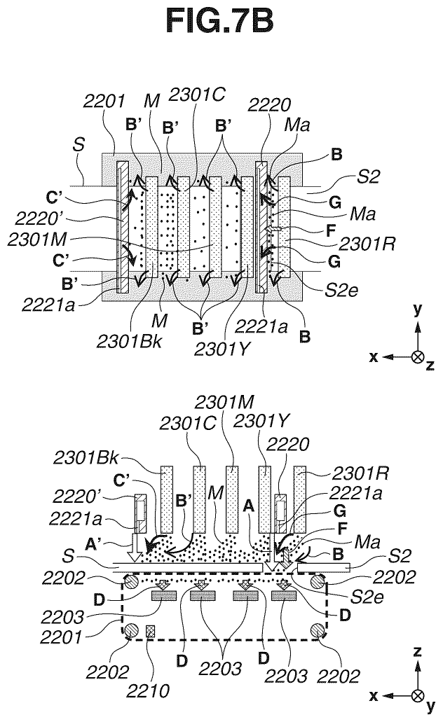

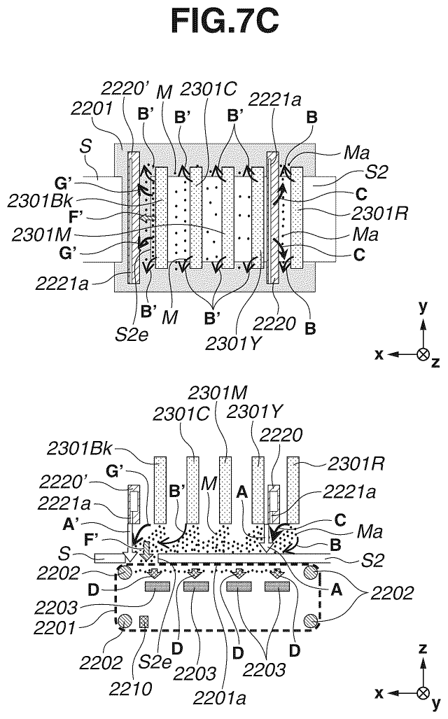

A configuration according to a third exemplary embodiment will be described below. Redundant descriptions of configurations similar to those according to the first or second exemplary embodiment are omitted. FIGS. 7A to 7C are schematic views illustrating a flow of collecting mist generated near the recording heads 2301 according to the third exemplary embodiment. FIG. 7A is a view illustrating a state where the suctioned and conveyed sheet S1 is located under the air curtain unit 2220 as viewed from the Z and Y directions. FIG. 7B is a view illustrating a state where the sheet S1 conveyed in the X direction and moved to a position downstream of the air curtain unit 2220 is viewed from the Z and Y directions. FIG. 7C is a view illustrating a state where the sheet S1 is further conveyed in the X direction and moved to a position downstream of the air curtain unit 2220′ as viewed from the Z and Y directions.

According to the present exemplary embodiment, the recording heads 2301R to 2301Bk are arranged in the same order as in the first exemplary embodiment. The air curtain unit 2220 is arranged between the recording heads 2301R and 2301Y, and an air curtain unit 2220′ arranged downstream of the recording head 2301Bk configured to eject the Bk ink are each arranged to face the printing belt 2201.

As the recording heads 2301 eject ink, the small mist M is generated along with main ink droplets. The mist M is moved downstream in the conveyance direction (X direction) by an airflow caused by the conveyance of the sheet S. Especially, in a case where the mist Ma generated from the recording head 2301R adheres to the recording head 2301Y, 2301M, 2301C, or 2301Bk, the reaction solution and the ink of the respective colors on the front surfaces of the recording heads 2301 may solidify through a reaction, and the recording heads 2301 may become defective in ejection. A suitable example of a case where a great amount of mist Ma is generated from the recording head 2301R and a great amount of mist M is generated from the recording heads 2301Y to 2301Bk of the respective colors according to the present exemplary embodiment will be described below.

In a case where the sheet S1 is located under the air curtain units 2220 and 2220′ as illustrated in FIG. 7A, the mist Ma generated from the recording head 2301R flows downstream in the X direction due to an airflow caused by the conveyance of the sheet S. Meanwhile, near both end portions of the sheet S in the Y direction, a portion of the mist Ma is suctioned in the arrow B directions due to an airflow with which the suction units 2203 suction the sheet S through the intake holes 2201a, and the portion of the mist Ma is suctioned by the suction units 2203. The mist Ma generated near the center of the width of the sheet S in the Y direction is not carried by the airflow along the arrow B because the sheet S is suctioned to the intake holes 2201a, and the mist Ma is conveyed further downstream by an airflow caused by the conveyance of the sheet S. After the mist Ma reaches close to the air curtain unit 2220, the airflow in the X direction is obstructed by an air curtain (arrow A) formed by the air outlet 2221a of the air curtain unit 2220, and the mist Ma is conveyed to both end portions of the sheet S in the Y direction (arrow C). The mist Ma conveyed to both end portions of the sheet S in the Y direction is conveyed through the exposed intake holes 2201a of the printing belt 2201 and collected by the mist filters 2205 of the suction units 2203 (arrow D).

Like the mist Ma, the mist M generated from the recording heads 2301Y, 2301M, 2301C, and 2301Bk flows downstream in the X direction due to an airflow caused by the conveyance of the sheet S. Meanwhile, near both end portions of the sheet S in the Y direction, a portion of the mist M is suctioned in the arrow B′ directions due to an airflow with which the suction units 2203 suction the sheet S through the intake holes 2201a, and the portion of the mist M is suctioned by the suction units 2203. The mist M generated near the center of the width of the sheet S in the Y direction is not carried by the airflow along the arrow B because the intake holes 2201a are blocked by the sheet S, and the mist M is conveyed further downstream by an airflow caused by the conveyance of the sheet S. After the mist M reaches close to the air curtain unit 2220′, the airflow in the X direction is obstructed by an air curtain (arrow A′) formed by the air outlet 2221a of the air curtain unit 2220′, and the mist M is conveyed to both end portions of the sheet S in the Y direction (arrow C′). The mist M conveyed to both end portions of the sheet S in the Y direction is conveyed through the exposed intake holes 2201a of the printing belt 2201 and collected by the mist filters 2205 of the suction units 2203 (arrow D).

FIG. 7B illustrates a case where the sheet S is conveyed to a position downstream of the air curtain unit 2220. Due to the airflow caused by the conveyance of the sheet S2 conveyed following the sheet S and the airflow suctioned by the suction units 2203, a portion of the mist Ma discharged from the recording heads 2301R is suctioned from both end portions of the sheet S2 in the Y direction in the arrow B directions to the printing belt 2201. However, the mist Ma that is not carried by the flow along the arrow B and remains is further conveyed downstream in the conveyance direction by the airflow caused by the conveyance of the sheet S2. After arriving at the end portion S2e of the sheet S2 in the X direction, the mist Ma is suctioned by the suction units 2203 through the intake holes 2201a of the printing belt 2201 that are exposed between the sheets S and S2 (arrow F). However, a portion of the mist Ma flows further downstream in the conveyance direction without being suctioned to the printing belt 2201, and after reaching near the air curtain unit 2220, the portion of the mist Ma is blown in arrow G directions by an air curtain (arrow A) formed by the air outlet 2221a of the air curtain unit 2220 and suctioned to the printing belt 2201. The mist Ma suctioned to the printing belt 2201 is conveyed through the intake holes 2201a of the printing belt 2201 and collected by the mist filters 2205 of the suction units 2203 (arrow D). The mist Ma attached to the back surface of the printing belt 2201 or near the intake holes 2201a is wiped off and removed by the cleaning unit 2210 as the printing belt 2201 is rotated.

The mist M generated from the recording heads 2301Y to 2301Bk of the respective colors flows downstream in the X direction due to an airflow caused by the conveyance of the sheet S. Meanwhile, near both end portions of the sheet S in the Y direction, a portion of the mist M is suctioned in the arrow B′ directions due to an airflow with which the suction units 2203 suction the sheet S through the intake holes 2201a, and the portion of the mist M is suctioned by the suction units 2203. However, the mist M generated near the center of the width of the sheet S in the Y direction is not carried by the airflow along the arrow B′ because the intake holes 2201a are blocked by the sheet S, and the mist M is conveyed further downstream in the X direction by an airflow caused by the conveyance of the sheet S.

After the mist M reaches close to the air curtain unit 2220′, the airflow in the X direction is obstructed by the air curtain (arrow A′) formed by the air outlet 2221a of the air curtain unit 2220′, and the mist M is conveyed to both end portions of the sheet S in the Y direction (arrow C′). The mist M conveyed to both end portions of the sheet S in the Y direction is conveyed through the exposed intake holes 2201a of the printing belt 2201 and collected by the mist filters 2205 of the suction units 2203 (arrow D). The mist M attached to the back surface of the printing belt 2201 or near the intake holes 2201a is wiped off and removed by the cleaning unit 2210 as the printing belt 2201 is rotated.

FIG. 7C illustrates a case where the sheet S is conveyed further downstream to a position downstream of the air curtain unit 2220′. The mist Ma generated from the recording heads 2301R flows downstream in the X direction due to an airflow caused by the conveyance of the sheet S2. Meanwhile, near both end portions of the sheet S2 in the Y direction, a portion of the mist Ma is suctioned in the arrow B directions due to an airflow with which the suction units 2203 suction the sheet S through the intake holes 2201a, and the portion of the mist Ma is suctioned by the suction units 2203. The mist Ma generated near the center of the width of the sheet S2 in the Y direction width is not carried by the airflow along the arrow B because the intake holes 2201a are blocked by the sheet S2, and the mist Ma is conveyed further downstream in the X direction by an airflow caused by the conveyance of the sheet S2. After the mist Ma reaches close to the air curtain unit 2220, the airflow in the X direction is obstructed by the air curtain (arrow A) formed by the air outlet 2221a of the air curtain unit 2220, and the mist Ma is conveyed to both end portions of the sheet S2 in the Y direction (arrow C). The mist Ma conveyed to both end portions of the sheet S2 in the Y direction are conveyed through the exposed intake holes 2201a of the printing belt 2201 and collected by the mist filters 2205 of the suction units 2203 (arrow D).

The mist M generated from the recording heads 2301Y to 2301Bk of the respective colors flows downstream in the X direction due to an airflow caused by the conveyance of the sheet S2. Meanwhile, near both end portions of the sheet S2 in the Y direction, a portion of the mist M is suctioned in the arrow B′ directions due to an airflow with which the suction units 2203 suction the sheet S through the intake holes 2201a, and the portion of the mist M is suctioned by the suction units 2203. The mist M generated near the center of the width of the sheet S2 in the Y direction is not carried by the airflow along the arrow B′ because the intake holes 2201a are blocked by the sheet S2, and the mist M is conveyed further downstream in the X direction by an airflow caused by the conveyance of the sheet S2. When the mist M reaches the end portion S2e of the sheet S2 in the X direction, the mist M is suctioned by the suction units 2203 through the intake holes 2201a of the printing belt 2201 that are exposed between the sheets S and S2 (arrow F′). However, a portion of the mist M flows further downstream in the conveyance direction without being suctioned to the printing belt 2201, and after reaching near the air curtain unit 2220′, the portion of the mist M is blown in arrow G′ directions by an air curtain (arrow A′) formed by the air outlet 2221a of the air curtain unit 2220′ and suctioned to the printing belt 2201. The mist M suctioned to the printing belt 2201 is conveyed through the intake holes 2201a of the printing belt 2201 and collected by the mist filters 2205 of the suction units 2203 (arrow D).

With the foregoing configuration, the mist M generated from the recording heads 2301R to 2301Bk of the respective colors is collected by the mist filter 2205 using the curtain-shaped airflow (arrow A, arrow A′) blown from the air outlet 2221a and the airflow with which the suction units 2203 suction the sheet S through the intake holes 2201a of the printing belt 2201, whereby the mist M is prevented from flowing downstream of the air curtain units 2220 and 2220′ in the conveyance direction.

Besides the first to third exemplary embodiments, the air curtain unit 2220 may be provided downstream of each recording head 2301.

The present disclosure makes it possible to provide a liquid ejection apparatus capable of collecting mist appropriately.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-103661, filed Jun. 23, 2023, which is hereby incorporated by reference herein in its entirety.

What is claimed is:

1. A liquid ejection apparatus comprising:
an ejection head configured to eject a liquid from an ejection portion to a first surface of an ejection target medium;
a conveyance unit facing the ejection portion and configured to convey the ejection target medium in a first direction;
an air delivery unit arranged downstream of the ejection head in the first direction and configured to deliver air to the conveyance unit; and
an intake unit facing the air delivery unit and configured to intake at least a portion of the air delivered by the air delivery unit,
wherein the intake unit includes a mist collection portion configured to collect mist generated by the ejection of the liquid from the ejection portion.

2. The liquid ejection apparatus according to claim 1,
wherein the conveyance unit includes a contact surface configured to be brought into contact with a second surface different from the first surface of the ejection target medium, and
wherein the intake unit intakes the air delivered by the air delivery unit through an intake hole of the contact surface.

3. The liquid ejection apparatus according to claim 2,
wherein the contact surface includes a first intake hole and a second intake hole arranged in a second direction intersecting with the first direction, and the intake unit is configured to perform intake through the first intake hole and the second intake hole,
wherein the first intake hole is in a region through which the ejection target medium conveyed by the conveyance unit passes, and
wherein the second intake hole is outside of the region.

4. The liquid ejection apparatus according to claim 3, wherein the air delivery unit is configured to blow the air from an air outlet that is open towards the first surface of the ejection target medium, and a length of the air outlet in the second direction intersecting with the first direction is greater than or equal to a length of the ejection target medium in the second direction.

5. The liquid ejection apparatus according to claim 4,
wherein the conveyance unit is configured to consecutively convey a plurality of ejection target mediums consecutively with a predetermined interval in the first direction, and
wherein the length of the air outlet in the second direction is shorter than the predetermined interval.

6. The liquid ejection apparatus according to claim 1, wherein the ejection head comprises a line head.

7. A liquid ejection apparatus comprising:
a first ejection head configured to eject a liquid from a first ejection portion to a first surface of an ejection target medium;
a second ejection head arranged downstream of the first ejection head in a first direction and configured to eject a liquid from a second ejection portion to the first surface of the ejection target medium, the first direction corresponding to a direction in which the ejection target medium is conveyed by a conveyance unit;
an air delivery unit arranged downstream of the first ejection head and upstream of the second ejection head in the first direction and configured to deliver air to the conveyance unit; and
an intake unit facing the air delivery unit and configured to intake at least a portion of the air delivered by the air delivery unit.

8. The liquid ejection apparatus according to claim 7, wherein, when the first ejection head ejects a first liquid, the first liquid is brought into contact with a second liquid ejected by the second ejection head to cause a decrease in fluidity of the second liquid.

9. The liquid ejection apparatus according to claim 7, wherein the intake unit includes a mist collection portion configured to collect mist generated by the ejection of the liquid from the first ejection portion and the ejection of the liquid from the second ejection portion.

10. The liquid ejection apparatus according to claim 7,
wherein the conveyance unit includes a contact surface configured to be brought into contact with a second surface different from the first surface of the ejection target medium, and
wherein the intake unit intakes the air delivered by the air delivery unit through an intake hole of the contact surface.

11. The liquid ejection apparatus according to claim 10,
wherein the contact surface includes a first intake hole and a second intake hole arranged in a second direction intersecting with the first direction, and the intake unit is configured to perform intake through the first intake hole and the second intake hole,
wherein the first intake hole is in a region through which the ejection target medium conveyed by the conveyance unit passes, and
wherein the second intake hole is outside of the region.

12. The liquid ejection apparatus according to claim 11, wherein the air delivery unit is configured to blow the air from an air outlet that is open towards the first surface of the ejection target medium, and a length of the air outlet in the second direction intersecting with the first direction is greater than or equal to a length of the ejection target medium in the second direction.

13. The liquid ejection apparatus according to claim 7, further comprising a second air delivery unit arranged downstream of the second ejection head in the first direction.

14. The liquid ejection apparatus according to claim 7, wherein the first ejection head is a line head and the second ejection head is a line head.
